(19) United States
(12) Patent Application Publication
(10) Pub. No.: US 2024/0010053 A1
(43) Pub. Date: Jan. 11, 2024

(54) METHOD FOR DE-ICING A FRONT WINDOW AND/OR A REAR WINDOW OF AN ELECTRIC VEHICLE

(71) Applicant: Dr. Ing. h.c. F. Porsche Aktiengesellschaft, Stuttgart (DE)

(72) Inventors: Benjamin Metsch, Pforzheim (DE); Robert Maly, Boeblingen (DE)

(21) Appl. No.: 18/213,998

(22) Filed: Jun. 26, 2023

(30) Foreign Application Priority Data
Jul. 11, 2022 (DE) 10 2022 117 212.0

(51) Int. Cl. B60J 1/00; G01N 27/04; G01W 1/10

(52) U.S. Cl. CPC B60J 1/002; G01N 27/041; G01W 1/10

(57) ABSTRACT

A method for de-icing a front window and/or a rear window of an electric vehicle includes setting a planned departure time of the electric vehicle, and, prior to the scheduled departure time, automatically checking or predicting whether there is icing of the front window and/or the rear window. If icing of the front window and/or the rear window is determined to exist, then a start time for a direct de-icing operation is calculated to ensure that sufficient time is allotted to have the front window and/or the rear window de-iced at the planned departure time. The method proceeds by activating the de-icing functions for direct de-icing of the front window and/or the rear window when the start time is reached.

### CROSS REFERENCE TO RELATED APPLICATION

This application claims priority on German Patent Application No 10 2022 117 212.0 filed Jul. 11, 2022, the entire disclosure of which is incorporated herein by reference.

### BACKGROUND

### Field of the Invention

The invention relates to a method for de-icing a front window and/or a rear window of an electric vehicle.

### Related Art

The term “electric vehicle” in the context of this application is intended to mean both a purely battery-electrically operated vehicle that is driven exclusively by one or more electric machines, as well as plug-in hybrid vehicles that comprise an engine as well as an electric machine as propulsion devices.

The front window and the rear window of an electric vehicle that is parked outdoors in frosty temperatures is apt to freeze. There are different options for removing ice from the vehicle windows to enable a safe start to a journey. For example, a mechanical ice scraper may be used to remove ice from the vehicle windows. However, this method often proves to be tedious and time-consuming and delays a safe start of the journey with the electric vehicle.

Ice also can be removed by manually activating an interior climate control apparatus of the electric vehicle. This de-icing process takes a long time because the entire vehicle interior is heated and not just the windows. Accordingly, this method also delays a safe start of the journey with the electric vehicle. Furthermore, this method is associated with an average power consumption that negatively affects the electrically achievable range of the electric vehicle.

Another method for removing ice from the vehicle window uses app-controlled or time-controlled, pre-climatization of the interior of the electric vehicle. This may be very comfortable but does not allow for differentiation as to whether ice is present on the vehicle windows or not. This method also heats the entire vehicle interior, and hence the de-icing process takes a comparatively long time. A further disadvantage is that heating the entire vehicle interior results in a noticeable reduction in the electrically achievable range of the electric vehicle.

Climate control systems in the electric vehicle do not function exclusively to de-ice the front window or the rear window, but rather function to climatize the entire vehicle interior. As noted above, the climate control of the vehicle interior is extremely energy intensive and takes a relatively long time, thereby negatively affecting the achievable electrical range of the electric vehicle. Interior climate control is not necessary for every driver or in every driving mode, in particular in a maximum-range driving mode. Nevertheless, clear visibility is necessary to ensure vehicle safety. Accordingly, there is a need for an option to de-ice the front window and the rear window without significantly heating the interior space.

US 2019/0061468 describes a method for de-icing a vehicle window. If the ambient temperature data exceeds a certain threshold temperature, the ambient light in the vehicle cabin is utilized to generate light intensity measurement data. This data is compared to sample data to optionally activate a window de-icing device.

The problem addressed by the present invention is to provide a need-based, energy-efficient and comfortable method for de-icing the front window and/or the rear window of the electric vehicle via heating devices already present in the electric vehicle.

### SUMMARY OF THE INVENTION

The invention relates to a method for de-icing a front window and/or a rear window of an electric vehicle. The method includes setting a planned departure time of the electric vehicle and then, prior to the scheduled departure time, automatically checking or predicting whether there is icing of the front window and/or the rear window. If icing of the front window and/or the rear window is determined to exist, the method includes calculating a start time by which the de-icing functions for direct de-icing of the front window and/or the rear window must be activated so that a de-icing of the front window and/or the rear window is achieved at the planned departure time. The method proceeds by activating the de-icing functions for direct de-icing of the front window and/or the rear window.

The method enables a needs-based, energy-efficient, and comfortable de-icing of the front window and/or the rear window of the electric vehicle via pre-existing heating devices to achieve a direct de-icing of the front window and/or the rear window. The de-icing function for the rear window is provided by an associated rear window heating device having electric heating elements, such as heating wires. The de-icing of the front window can be provided by an associated front window heating device that has electric heating elements and/or via a heating fan that has air outflow aimed directly at the inside of the front window. The front and/or rear window heating devices advantageously avoid a complete heating of the vehicle interior for de-icing the front window and/or rear windows. A heating fan that is used to de-ice the front window has an air outflow aimed directly at the inside of the front window. The heating fan advantageously is deactivated after de-icing the front window so that the interior of the vehicle is not fully heated. Thus, the method disclosed herein de-ices the front window and/or the rear window of the electric vehicle without significantly reducing the electrically achievable range of the electric vehicle compared to a complete pre-climatization of the vehicle interior.

Setting the planned departure time of the electric vehicle can be done in several ways. In one embodiment, the planned departure time of the electric vehicle is set by a departure timer or by a machine learning model or by a link to existing calendar entries of an electronic calendar. Setting the scheduled departure time using a departure timer can be done by using a vehicle app that enables different vehicle functions to be set by a user. For example, if the planned departure time of the electric vehicle is set automatically by a machine learning model, the machine learning model can be trained to predict a future departure time of the electric vehicle from departure times of the electric vehicle in the past. A further possibility is to set the departure time automatically by linking to existing appointment entries in an electronic calendar of the user of the electric vehicle. For example, the planned departure time of the electric vehicle can be calculated and set based on the start of an appointment stored in the electronic calendar and from the distance of the electric vehicle from the location of the appointment. The planned departure time can be stored in a memory of a control device that controls the de-icing.

In one embodiment, icing of the front window and/or the rear window is checked by an outside temperature sensor, an inside temperature sensor, and a humidity sensor. Thus, temperatures below the freezing point (0° C.) and the humidity are sensed to determine if the front window and/or the rear window are iced and need to be de-iced automatically prior to commencing the journey. For example, a rain sensor also can be used to sense moisture on the front window of the electric vehicle.

In one embodiment, mechanical resistance is sensed during small movements of a window wiper to check the icing of the front and/or rear window. Thus, icing of the front window of the electric vehicle can be sensed by detecting mechanical resistance on a window wiper during its movement. Very small pivoting movements of the window wiper can be triggered by an initialization circuit, and the mechanical resistance on the wiper is determined. This mechanical resistance is significantly greater when moving on an iced front window than when moving on a non-iced front window, so that front window icing can be detected. If the electric vehicle is equipped with a rear window wiper, icing can be detected there in an analogous manner by determining the mechanical resistance with very small movements of the rear window wiper.

In one embodiment, icing of the rear window can be checked by measuring changes in an electrical resistance of electrical heating elements of a rear window heating device. The electrical resistance of these heating elements is temperature-based, an icing of the rear window can be sensed by measuring changes of the resistance. Icing of the front window similarly can be checked by measuring changes in an electrical resistance of electrical heating elements of a front window heating device.

A front camera of the electric vehicle can be used to check the icing of the front window. Icing of the front window can be captured by image processing software that is configured to evaluate the image data of the front camera.

A machine learning model is used in some embodiments to check the icing of the front window and/or the rear window. The machine learning model is trained to predict the need for activating de-icing functions from operator inputs of a user with respect to de-icing functions of the front window and/or the rear window in past in comparable ambient conditions.

In a further embodiment, meteorological data is captured, processed and used automatically by the electric vehicle to predict the icing of the front window and/or the rear window. A need for de-icing can be inferred from meteorological data, such as temperature, humidity, and wind conditions at the location of the electric vehicle. For example, a push message be generated based on the meteorological data and transmitted from the electric vehicle via a wireless network to a cell phone or other computing device of the user to inform the vehicle user of likely frozen vehicle windows.

The different approaches by means of which icing of the front window and/or the rear window can be detected or predicted can be combined with one another.

Further features and advantages of the invention will become apparent from the following description and the accompanying drawing.

### BRIEF DESCRIPTION OF THE DRAWING

FIG. 1 is a flow chart that schematically illustrates a simplified basic sequence of a method for de-icing a front window and/or a rear window of an electric vehicle.

### DETAILED DESCRIPTION

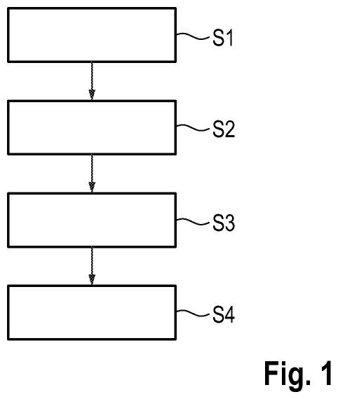

A method in accordance with the invention is illustrated schematically in FIG. 1 and includes a first step S1 of setting a planned departure time of the electric vehicle. This can be done in many different ways. For example, the departure time can be set by a departure timer, such as a vehicle app. This is analogous to a time-based activation of a pre-climatization of a vehicle interior using a vehicle app. The setting of the planned departure time of the electric vehicle can also be automated by a machine learning model that is trained to predict a future departure time of the electric vehicle from departure times of the electric vehicle in the past. Still further, the departure time can be set automatically by linking to existing appointment entries in an electronic calendar of a user of the electric vehicle. For example, the planned departure time of the electric vehicle can be calculated and set based on the start of the appointment stored in the electronic calendar and the distance of the electric vehicle from the location of the appointment. Traffic data automatically received by the electric vehicle also can be included in the calculation of the planned departure time of the electric vehicle. The planned departure time can be stored in a memory of a control device that controls the de-icing process.

A second step S2 occurs prior to the scheduled departure time and includes automatically checking or predicting whether there is icing of the front window and/or the rear window. This check is performed in a timely manner prior to the departure time set in method step S1, so that there is still sufficient time to start the corresponding de-icing functions and to de-ice the front window and/or the rear window of the electric vehicle in a timely manner prior to the planned start of the journey.

The automated checking or predicting of whether the front and/or rear window is iced can be carried out in different ways.

One embodiment includes using an external temperature sensor, an internal temperature sensor, and a humidity sensor. Temperatures below the freezing point (0° C.) and specified humidity levels can lead to a conclusion that the front window and/or the rear window are iced and need to be de-iced prior to commencing the journey. A rain sensor can also be used to sense moisture on the front window of the electric vehicle.

A variant of the method includes sensing mechanical resistance during small pivoting movements of a window wiper to check the icing of the front window and/or the rear window. An icing of the front window of the electric vehicle can be sensed by detecting a mechanical resistance of a window wiper. In this case, very small movements of the window wiper are triggered by an initialization circuit, and the mechanical resistance that occurs during the movement is determined. This mechanical resistance is significantly greater on an iced front window than on a non-iced front window, so that front window icing can be detected. If the electric vehicle is equipped with a rear window wiper, an icing of the rear window can be detected in an analogous manner by determining mechanical resistance with very small movements of the rear window wiper.

A further possibility for sensing icing of the front window includes using a front camera that can be located behind the front window of the electric vehicle. This aspect of the invention includes using image processing software that is configured to evaluate the image data of the front camera for capturing icing of the front window.

The rear window of the electric vehicle comprises a rear window heating device having plural electric heating elements, such as heating wires. These electric heating elements can be pressed on the inside of the rear window or can be integrated into the rear window. Icing of the rear window can be sensed by measuring changes in the electrical resistance of these heating elements, which are temperature-based.

The front window of the electric vehicle also may comprise a front window heating device having plural electric heating elements. Icing of the front window can be detected by measuring changes in the temperature-dependent electrical resistance of these heating elements, in a manner analogous to the rear window.

A further possibility for sensing icing of the vehicle windows is to use a machine learning model that is trained to predict the need for activating de-icing functions of the front window and/or the rear window from operator inputs of a user with respect to de-icing functions of the vehicle windows in the past in comparable ambient conditions.

The method also may include using predictive information in the form of meteorological data. Predicted temperature, humidity and wind conditions at the location of the electric vehicle can lead to an inference that de-icing of the vehicle windows could become necessary. The meteorological data may cause generation of a push message that informs the vehicle user of likely frozen vehicle windows and the need for de-icing at an early point. Such a push message may advise the user, for example, “Frost possible tomorrow.”

Step S3 includes calculating a deicing start time if the previous step S2 has detected front and/or rear window icing. The start time is calculated in a step S3 to ensure that the windows are finished being de-iced at the scheduled departure time.

In a step S4, the de-icing functions for de-icing the front window and/or the rear window of the electric vehicle are started.

The de-icing of the rear window is carried out by means of the rear window heating device associated therewith. The de-icing of the front window can be carried out by the front window heating device and/or via a heating fan, whose air outflow is aimed directly at the inside of the front window. After de-icing, the heating fan is deactivated, so that the interior of the vehicle is not fully heated.

The method presented herein de-ices the front window and/or the rear window of the electric vehicle without a significant reduction in the electrically achievable range of the electric vehicle compared to a complete pre-climatization of the vehicle interior. Thus, a needs-based, energy-efficient, and comfortable de-icing of the front window and/or the rear window of the electric vehicle is enabled via the heating systems already present in the electric vehicle, without the need to heat the vehicle interior completely. The user can be informed of an icing of the vehicle windows and an activated de-icing function, for example by a push message received by a cell phone of the user.

1. A method for de-icing a front window and/or a rear window of an electric vehicle, comprising:
setting a planned departure time of the electric vehicle;
automatically checking or predicting prior to the scheduled departure time whether there is icing of the front window and/or the rear window,
calculating a start time for any required de-icing if there is icing of the front window and/or the rear window to ensure that any required de-icing is complete at the planned departure time,
starting direct de-icing of the front window and/or the rear window at the start time.

2. The method of claim 1, wherein the planned departure time of the electric vehicle is set by a departure timer.

3. The method of claim 1, wherein the planned departure time of the electric vehicle is set by a machine learning model.

4. The method of claim 1, wherein the planned departure time of the electric vehicle is set by a link to existing calendar entries of an electronic calendar.

5. The method of claim 1, wherein checking the icing of the front window and/or the rear window includes using an outside temperature sensor, an inside temperature sensor, and a humidity sensor.

6. The method of claim 1, wherein checking icing of the front window and/or the rear window includes sensing mechanical resistance during small movements of a window wiper.

7. The method of claim 1, wherein checking the icing of the rear window includes measuring changes of electrical resistance of electrical heating elements of a rear window heating device.

8. The method of claim 1, wherein checking the icing of the front window includes measuring changes of electrical resistance of electrical heating elements of a front window heating device.

9. The method of claim 1 wherein checking the icing of the front window includes using a front camera of the electric vehicle.

10. The method of claim 1, wherein checking the icing of the front window and/or the rear window includes using a machine learning model that is trained to predict a need for activating de-icing functions from operator inputs of a user with respect to de-icing functions of the front window and/or the rear window in past comparable ambient conditions.

11. The method of claim 1, further comprising using meteorological data that is automatically captured by the electric vehicle to predict icing of the front window and/or the rear window.
